(19) United States
(12) Patent Application Publication
(10) Pub. No.: US 2026/0149937 A1
(43) Pub. Date: May 28, 2026

(54) ELECTRONIC SOUND RECORDING DEVICE, IN PARTICULAR HEARING INSTRUMENT

(71) Applicant: WIDEX A/S, Lynge (DK)

(72) Inventors: Jens DENBORG, Lynge (DK); Elisabet TIANA-ROIG, Lynge (DK)

(73) Assignee: WIDEX A/S, Lynge (DK)

(21) Appl. No.: 19/121,268

(22) PCT Filed: Oct. 10, 2023
(86) PCT No.: PCT/EP2023/077976

§ 371 Date: Apr. 15, 2025

(30) Foreign Application Priority Data
Oct. 25, 2022 (DK) PA202270513

(51) Int. Cl. H04R 25/00; H04R 1/08

(52) U.S. Cl. CPC H04R 25/609; H04R 1/086; H04R 25/48; H04R 2201/003

(57) ABSTRACT

An electronic sound recording device having a housing, a housing wall and an opening through which sound can enter. The housing has a printed circuit board having a through-hole as a sound channel. A microphone has a microphone port mounted on and facing the printed circuit board and open to the through-hole. A sound duct having a sound passage arranged between the printed circuit board and housing wall. The sound passage connects the opening of the housing wall to the through-hole of the printed circuit board. The device has a washer having a bore and arranged between the printed circuit board and the sound duct such that the sound passage is connected to the through-hole of the printed circuit board via the bore. To achieve effective acoustic low pass filtering, the bore has a diameter smaller than both a diameter of the through-hole and a diameter of the sound passage.

### The invention relates to an electronic sound recording device, in particular to a hearing instrument, according to the first part of claim 1.

In general, the term “electronic sound recording device” as used herein relates to an electronic device that includes at least one microphone (also referred to as the “input transducer”) for recording air-borne sound, i.e. for converting air-borne sound into an electric signal transporting the sound information (audio signal). Electronic sound recording devices, e.g., include lavalier microphones, hands-free speaking systems, mobile telephones, notebooks or tablet computers and hearing instruments.

The term “hearing instrument” as used herein relates to a particular type of electronic sound recording devices being designed to support the hearing of a person wearing it (which person is called the user or wearer of the hearing instrument). In particular, the invention relates to a hearing aid, i.e., a hearing instrument that is specifically configured to at least partially compensate a hearing impairment of a hearing-impaired user. Other types of hearing instruments are designed to support the hearing of normal hearing users, i.e., to improve speech perception in complex acoustic situations. The term “hearing instrument” also includes a headset, a noise-cancelling headphone or ear bud, etc.

In addition to at least one microphone, a hearing instrument includes an acoustoelectric transducer (also referred to as the “output transducer”) being designed to convert an audio signal (i.e., as mentioned above, an electric signal transporting a sound information) in a signal that can be perceived as sound by the user. Most often, hearing instruments are designed to be worn in or at the ear of the user, e.g., as a Behind-The-Ear (BTE) or In-The-Ear (ITE) instrument. With respect to its internal structure, a hearing instrument normally comprises a signal processor in addition to the input and output transducers mentioned above. During operation of the hearing instrument, the input transducer captures air-borne sound from an environment of the hearing instrument and converts it into an input audio signal. In the signal processor, the input audio signal (transporting the information on the captured sound) is processed, e.g. amplified dependent on sound frequency to support the hearing of the user, in particular to compensate a hearing-impairment of the user. The signal processor outputs a processed audio signal (carrying the information of the processed sound) to the output transducer. Most often, the output transducer is an electro-acoustic transducer (also called “receiver”) that converts the processed audio signal into a processed air-borne sound, which is emitted into the ear canal of the user. Alternatively, the output transducer may be an electro-mechanical transducer that converts the processed audio signal into a structure-borne sound (vibrations) that is transmitted, e.g., to the cranial bone of the user. Furthermore, besides classical hearing instruments as described before, there are implanted hearing instruments such as cochlear implants, and hearing instruments the output transducers of which output the processed sound by directly stimulating the auditory nerve of the user.

The term “hearing system” denotes one device or an assembly of devices and/or other structures providing functions required for the operation of a hearing instrument. A hearing system may consist of a single stand-alone hearing instrument. As an alternative, a hearing system may comprise a hearing instrument and at least one further electronic device, which may be, e.g., one of another hearing instrument for the other ear of the user, a remote control, a programming tool and an external microphone for the hearing instrument. Moreover, modern hearing systems often comprise a software application for controlling and/or programming the hearing instrument, which software application is or can be installed on a computer or a mobile communication device such as a mobile phone (smartphone). In the latter case, typically, the computer or the mobile communication device are not a part of the hearing system. Most often, the computer or the mobile communication device will be manufactured and sold independently of the hearing system.

In small electronic sound recording devices such as hearing instruments, so-called MEMS (Micro Electro-Mechanical Systems) microphones are often used, due to their small size and due to the fact that MEMS microphones can be surface mounted to a printed circuit board (PCB).

However, a known problem of MEMS microphones is their high sensitivity at high sound frequencies above the operational range of the electronic sound recording device, in particular ultra-sound frequencies. When recording sound using a MEMS microphone, elevated high frequency components of the recorded sound may be mapped into the operation range of the device, as a consequence of subsequent signal processing, thereby creating unwanted artifacts (aliasing). Moreover, in extreme cases, high frequency portions of the recorded sound may overload the MEMS microphone making it fail temporarily. An example of sounds that are likely to cause such artefacts or acoustic overload (AOL) is key rattling which typically produces a large amount of high frequency sounds. Once the MEMS microphone is overloaded there is no means to correct the issue afterwards. Hence, these high frequency signals should be attenuated before they reach the MEMS microphone.

Usually, a MEMS microphone is mounted on a PCB with the microphone port (and, thus, the microphone membrane) facing towards the PCB surface. The PCB has a through-hole at the microphone port position. Hence, the sound will pass through the through-hole of the PCB before hitting the MEMS microphone.

A typical approach of attenuating the high frequency sounds consists in placing an acoustical filter in front of the microphone port of the MEMS microphone. Often, this is done by reducing the diameter of the through-hole in the PCB. However, the tolerances for the through-hole (as to the diameter, the length and the horizontal placement of the through-hole) must be very small in order to ensure the required (low pass) filter characteristics. With standard PCBs, the required precision is often difficult or even impossible to achieve. Furthermore, reducing the diameter of the through-hole of the PCB would lead to reduced mounting tolerance of the MEMS microphone and, thus, enhanced complexity of manufacture since perfect overlap of the microphone port with the through-hole of PCB needs to be ensured.

Another way of realizing an acoustic low pass filter, as disclosed in U.S. Pat. No. 8,724,841 B2, consists in placing a protective mesh in the sound passage leading to the microphone port.

An electronic sound recording device, i.e. a hearing aid, according to the first part of claim 1 is known from EP 3 471 434 A1 . In this hearing aid, an acoustic low pass filter is formed by a snout element, which is provided opposing the MEMS microphone on the other surface of the PCB. The snout element comprises a passage extending therethrough. One end of said passage faces a through-hole in the PCB. The passage forms an acoustic channel and is configured to be longer than the length of the through-hole in the printed circuit board. At least a part of the passage has a cross-sectional area which is smaller than the area of the through-hole in the PCB.

An object of the present invention is to provide an electronic sound recording device, in particular a hearing instrument, in which acoustic low pass filtering is realized in a simple to manufacture yet effective manner.

According to the invention the above object is met by an electronic sound recording device, in particular a hearing instrument, as defined by claim 1. Preferred embodiments of the invention are described in the dependent claims and the subsequent description.

The electronic sound recording device (subsequently referred to as the “device”) according to the invention comprises a housing that has a housing wall. An opening is formed in the housing wall through which (air-borne) sound can enter the housing. A printed circuit board (PCB) is arranged in said housing. The PCB has a through-hole that acts as a sound channel through said PCB. A microphone having a microphone port (i.e. a sound inlet through which a membrane of the microphone can be exposed to sound) is mounted on said PCB such that said microphone port faces said PCB and opens to said through-hole of the PCB. In other words, the microphone is mounted to the PCB such that its microphone port is (at least roughly) aligned and, thus, overlaps with the through-hole of the PCB. Preferably, the microphone port has a smaller diameter than the through-hole and, thus, entirely overlaps with the latter. Furthermore, the device comprises a sound duct having a sound passage formed therein and being arranged between the PCB and the housing wall such that said sound passage connects said opening of the housing wall to said through-hole of the PCB. Within the scope of the invention, the sound duct may be realized as a monolithic part of the housing. However, in preferred embodiments, the sound duct is a separate part of the device being detachable from and manufactured independently of the housing and other structures of the device.

According to the invention, the device further comprises a washer having a bore. Said washer is arranged between the PCB and the sound duct such that the sound passage of the sound duct is connected to the through-hole of the PCB via said bore of the washer. Said bore has a diameter that is smaller than both a diameter of said through-hole of the PCB and a diameter of said sound passage of the sound duct. In accordance with the invention the diameter of sound passage formed in the sound duct may be constant or vary along the length of the sound passage. In the latter case, preferably, the bore of the washer is formed with a diameter that is smaller than the minimum diameter of said sound passage of the sound duct. Also, in accordance with the invention the diameter of through-hole formed in the PCB may be constant or vary along the length of said through-hole (i.e. along the thickness of the PCB). In the latter case, preferably, the diameter of the bore of the washer is formed such that it is smaller than the minimum diameter of said through-hole of the PCB.

The term “washer” as used herein relates to a plate-shaped body having a lateral extension (extending perpendicular to an axis of said bore) that is large in comparison to its thickness (extending parallel to said axis of said bore); preferably, the lateral extension of the washer is at least two times, preferably at least four times larger than its thickness. Preferably, the outer contour of the washer is circular. However, within the scope of the invention, the washer may have a different outer contour such as, e.g. a polygonal shape, a shape of a polygon with rounded edges, an oval shape or even an irregular shape. In preferred embodiments, the washer is a simple monolithic part being made of a uniform material. In particular, the washer is made of metal. However, in further embodiments of the invention, the washer may made of another rigid material such as a rigid plastic or ceramic material. Herein, “rigid” means sufficiently rigid such that the washer does not deform under normal sound pressure. Preferably, the thickness of the washer (and, thus, the length of the bore) is significantly smaller than the thickness of the PCB (and, thus, the length of the through-hole); in particular, the washer has a thickness between 0.05 and 0.3 mm, for instance ca. 0.1 mm.

The term “bore” refers to a hole extending over the entire thickness of the washer. This term “bore” is selected in order to better distinguish said hole formed in washer from other holes, passages and openings of the device such as the “through-hole” of the PCB, the “sound passage” of the sound duct and the “opening” of the housing wall. While, preferably, the bore is manufactured by drilling, the term “bore” does not specify a specific way of manufacturing the washer. Preferably, the bore is centered with respect to an outer contour of the washer. Preferably, the bore has a circular cross-sectional area. However, within the scope of the invention, different shapes of the bore such as a polygonal cross-sectional area are possible. Preferably, the bore has a constant diameter along its length. Preferably, the bore defines a free opening (i.e. an empty volume) that is not blocked by any other structure of the device, neither entirely nor partially, and into which no other structure of the device extends.

As explained above, according to the invention the washer inserted between the sound duct and the circuit board is used to define the narrowest section (so to speak the “needle eye”) of the sound path formed between the opening of the housing wall and the microphone port which “needle eye” is decisive for the acoustic low pass characteristic of said sound path. As the inventors recognized, it is easy to manufacture the bore of the washer (and, thus, the “needle eye” of the sound path) with a high precision, due to the flat, plate-like shape that is typical for a washer. Thus, by using the washer, acoustic low pass filtering is realized in a simple to manufacture but effective manner. On the other hand, using the washer to define the “needle eye” of the sound path allows for manufacturing the through-hole of the PCB and the sound passage of the sound duct with larger diameters and enhanced tolerance. This, again, significantly simplifies the manufacture of the device. In particular, the mounting the microphone on the PCB (and, thus, aligning the microphone port with the through-hole of the PCB) is largely simplified, due to an increased diameter of said through-hole; i.e. precise alignment is not necessary.

In preferred embodiments of the invention, the microphone is a MEMS microphone. The MEMS microphone may be either an analog or a digital MEMS microphone. However, applying the invention to a digital MEMS microphone (as is preferred) is of particular benefit, due to the very pronounced resonance peak of these microphones at high sound frequencies. Furthermore, in accordance with the invention, other microphone types such as, e.g., electret microphones can be used.

In suited embodiments of the invention, the washer abuts the printed circuit board. Preferably, the washer is directly soldered to the printed circuit board. In particular, a reflow soldering process is used to mount the washer to the PCB. In this case, the washer is automatically aligned with the through-hole of the PCB during soldering. However, within the scope of the invention different methods for mounting the washer to the PCB can be used. In particular, the washer may be glued to the PCB.

In preferred embodiments of the invention, the diameter of the bore of the washer is between 0.2 mm to 0.6 mm, preferably between 0.3 mm and 0.5 mm, in particular ca. 0.4 mm. The through-hole of the PCB may have a diameter, e.g., between 0.5 mm and 1.2 mm, preferably between 0.7 mm and 0.9 mm, in particular ca. 0.8 mm.

In order to improve the acoustic low pass filter characteristic of the sound path, optionally, at least one protection mesh spanning the bore of the washer or the through-hole of the PCB is inserted in the sound path formed between the opening of the housing wall and the microphone port. The protection mesh is also effective to protect the microphone port from ingress. Preferably, the at least one protection mesh is arranged between the washer and the sound duct and/or between the washer and the printed circuit board and/or between the printed circuit board and the microphone. Furthermore, if the sound duct is manufactured independently of the housing, as a separate part, the at least one protection mesh may also be inserted between the housing and the sound duct. A conventional acoustic mesh as manufactured, e.g., by SAATI S.p. A (IT), for instance “SAATIFIL ACOUSTEX®075”, may be used as the at least one protection mesh.

In a preferred embodiment, an insulating core of the PCB is made of FR-4 (as defined in the NEMA LI 1-1998 standard).

In a preferred embodiment of the invention, the device is a hearing instrument as defined above, in particular a hearing aid. In another preferred embodiment of the invention, the device is an external microphone unit (i.e. a remote unit comprising least one microphone) that is part of a hearing system.

Subsequently, embodiments of the present invention will be described with reference to the accompanying drawings in which

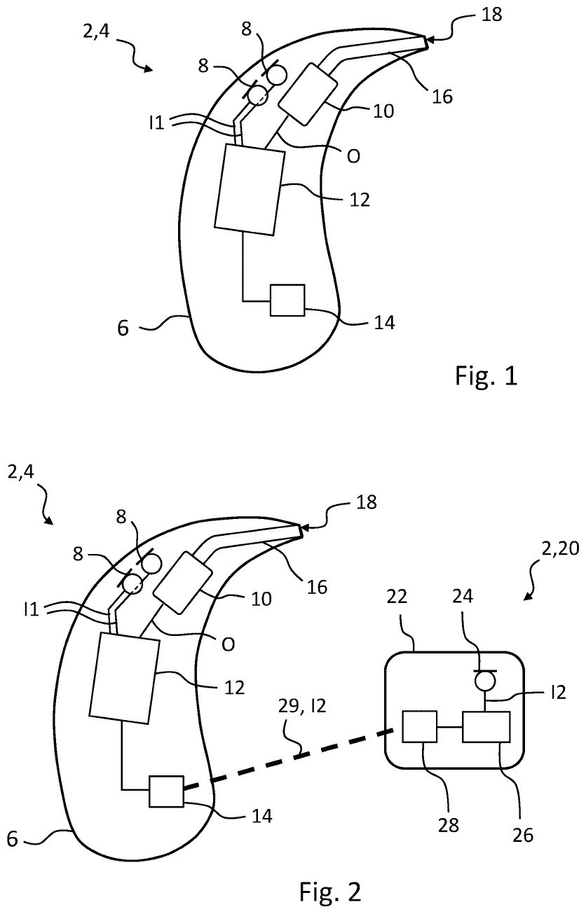

FIG. 1 shows a schematic representation of a hearing system comprising a hearing aid, the hearing aid comprising an input transducer arranged to capture a sound signal from an environment of the hearing aid, a signal processor arranged to process the captured sound signal, and an output transducer arranged to emit the processed sound signal to a user;

FIG. 2 shows a schematic representation of another hearing system comprising a hearing aid as shown in FIG. 1 and a remote unit comprising an external microphone; and

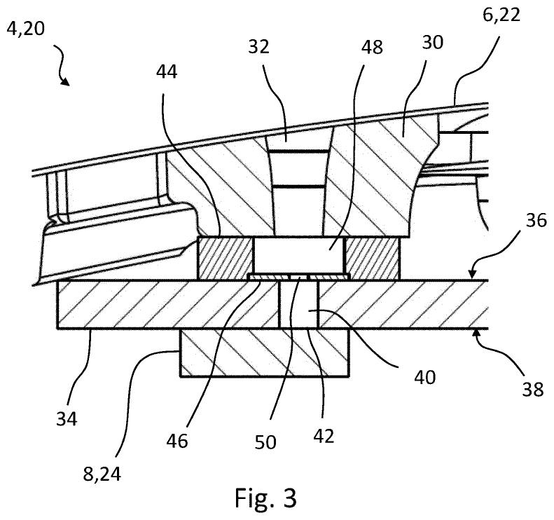

FIG. 3 shows a cross-sectional view through a part of an electronic sound recording device that may be, e.g., the hearing instrument of FIG. 1 or 2 or the external microphone unit of FIG. 2, said device comprising a housing having a housing wall, a sound duct, and a printed circuit board (PCB) having a MEMS microphone mounted thereon, wherein a sound path is formed between an opening of the housing wall, a sound passage of the sound duct and a through-hole of the PCB, and wherein a washer is inserted between the sound duct and the PCB such that a bore of the washer forms the narrowest section of said sound path.

Like reference numerals indicate like parts, structures and elements unless otherwise indicated.

FIG. 1 shows a hearing system 2 comprising a hearing aid 4, i.e., a hearing instrument being configured to support the hearing of a hearing-impaired user, that is configured to be worn in or at one of the ears of the user. As shown in FIG. 1, by way of example, the hearing aid 4 may be designed as a Behind-The-Ear (BTE) hearing aid. Optionally, the hearing system 2 comprises a second hearing aid (not shown) to be worn in or at the other ear of the user to provide binaural support to the user.

The hearing aid 4 comprises, inside a housing 6, two microphones 8 as input transducers and a receiver 10 as output transducer. The hearing aid 4 further comprises a battery (not shown) and a signal processor 12. Preferably, the signal processor 12 comprises both a programmable sub-unit (such as a microprocessor) and a non-programmable sub-unit (such as an ASIC). The signal processor 12 is powered by the battery, i.e., the battery provides an electric supply voltage to the signal processor 12. Moreover, in some embodiments, the hearing aid 4 comprises a wireless transceiver 14 (preferably a Bluetooth transceiver) for wireless data exchange with other devices (not shown in FIG. 1) that may or may not be parts of the hearing system 2.

During normal operation of the hearing aid 4, the microphones 8 record (capture) an air-borne sound from an environment of the hearing aid 2. The microphones 8 convert the air-borne sound into a first input audio signal I1 (also referred to as the “captured sound signal”), i.e., an electric signal containing information on the captured sound. The input audio signal I1 is fed to the signal processor 12. The signal processor 12 processes the input audio signal I1, e.g., to provide a directed sound information (beam-forming), to perform noise reduction and dynamic compression, and to individually amplify different spectral portions of the input audio signal I1 based on audiogram data of the user in order to compensate for the user-specific hearing loss. The signal processor 12 emits an output audio signal O (also referred to as the “processed sound signal”), i.e., an electric signal containing information on the processed sound to the receiver 10. The receiver 10 converts the output audio signal O into processed air-borne sound that is emitted into the ear canal of the user, via a sound channel 16 connecting the receiver 10 to a tip 18 of the housing 6 and a flexible sound tube (not shown) connecting the tip 18 to an ear piece (not shown) inserted in the ear canal of the user.

In a different embodiment (not shown), the hearing aid 4 may be designed as a RIC device. In this case, different from FIG. 1, the receiver 10 of the hearing aid 4 is located in the ear piece and, thus, outside the housing 6. Instead of the sound channel 16 and the sound tube, the RIC hearing aid 4 comprises an electric wire that connects the ear piece to the housing 6 and is used for feeding the output audio signal O from the signal processor 12 to the external receiver 10.

FIG. 2 shows yet another embodiment of the invention in which the hearing system 2 comprises a remote unit 20 further to the hearing aid 4. The word “remote” indicates that the unit 20 is separate from the hearing aid 4. The latter may be, e.g., identical with the hearing aid 4 of FIG. 1 or realized a RIC instrument as described above.

Arranged inside a housing 22, the remote unit 20 comprises at least one external microphone 24 (wherein “external” means that the microphone 24 is located outside the housing 6 of the hearing aid 4). In preferred embodiments, the remote unit 24 comprises a plurality of external microphones 24, e.g. for applying beamforming. The remote unit 20 also comprises an electronic controller 26, to which the microphone 24 (or each one of the plurality of microphones 24) is connected, and a wireless transceiver 28. The controller 26 may be realized as a programmable unit (such as a microprocessor) or a non-programmable unit (such as an IC) or comprise a combination of programmable and non-programmable hardware. The wireless transceiver 28 is compatible with the wireless transceiver 14 of the hearing aid 4.

In a preferred mode of operation of the hearing system 2 of FIG. 2, the at least one external microphone 24 of the remote unit 20 is used to record (capture) an air-borne sound from an environment of the remote unit 20. For instance, the sound captured by the microphone(s) 24 may contain the voice of the user (e.g. in a free-hands telephone call) or the voice of a different person. The microphone(s) 24 convert(s) the captured sound into a second input audio signal I2 and feed(s) this signal to the controller 26. The controller 26 relays the second input audio signal I2 to the signal processor 12 of the hearing aid 4, using a wireless link 29 established between the transceiver 28 of the remote unit 20 and the transceiver 14 of the hearing aid 4.

The inventive concept generally described above can be applied to any of the embodiments of the hearing aid 4 described above as well as to the remote unit 20. Thus, one of or both the hearing aid 4 and the remote unit 20 can be realized as a sound recording device according to the invention as illustrated in FIG. 3 in more detail. It can be seen therein that the housing 6 or 22 of the device (i.e. the hearing aid 4 or the remote unit 20, respectively) has housing wall 30 in which an opening 32 is formed. A printed circuit board (PCB 34) is arranged inside said housing 6 or 22. The PCB 34 has a first surface 36 that faces the opening 32 of the housing wall 30, and a second surface 38 that faces away from said opening 32. A (preferably circular) through-hole 40 is formed in the PCB 34 connecting the first surface 36 and the second surface 38.

A microphone (which may be one of the microphones 8 of the hearing aid 4 or the external microphone 24 of the remote unit 20) is mounted to the second surface 38 the PCB 34 such that a microphone port 42 of said microphone 8,24 faces the PCB 34 and opens to the through-hole 40. Thus, the microphone port 42 is at least roughly aligned with the through-hole 40 such that it entirely overlaps with the latter. Preferably, the microphone 8 or 24 as shown in FIG. 3 is realized as a digital MEMS microphone.

A sound duct 44 and a washer 46 are placed between the housing wall 30 and the PCB 34. In the embodiment shown in FIG. 3, the sound duct 44 is manufactured as a separate, e.g. essentially pipe-shaped part which is preferably made of rubber or an elastomer foam. The sound duct 44, thus, acts as an acoustic seal between the housing wall 30 and the PCB 34. To this end, the sound duct 44 is inserted between the housing wall 30 and the PCB 34 such that it abuts both an inner surface of the housing wall 30 and the first surface 36 of the PCB 34. The sound duct 44 has a central sound passage 48 that is aligned with the opening 32 of the housing wall 30 and the through-hole 40 of the PCB 34. The washer 46 is placed between the PCB 34 and the sound duct 44. Preferably, it is made as a thin circular metal plate that is directly soldered to the first surface 36 of the PCB 34 using a reflow soldering process such that a central bore 50 of the washer 46 is (at least approximately) centered with respect to the through-hole 40 of the PCB 34 and the sound passage 48 of the sound duct 44 such that the bore 50 entirely overlaps with the through-hole 40 and the sound passage 48.

In the mounted state of the device (i.e. hearing aid 4 or the remote unit 20) shown in FIG. 3, the opening 32 of the housing wall 30, the sound passage 48 of the sound duct 44, the bore 50 of the washer 46 and the through-hole 40 of the PCB 34 form a sound path acoustically connecting the microphone port 42 to the outside of the device (i.e. the hearing aid 4 or the remote unit 20). It can be seen in FIG. 3 that the bore 50 of the washer 46 forms the narrowest section of said sound path. Thus, the bore 50 of the washer 46 has a diameter smaller than a diameter of the through-hole 40 of the PCB 34, a diameter of the sound passage 48 of the sound duct 44 and a minimum diameter of the opening 32 of the housing wall 30. In a suited realization, the bore 50 has a diameter of 0.4 mm, whereas the through-hole 40 has a diameter of 0.8 mm.

Moreover, the washer 46 has a thickness being significantly smaller than the thickness of the PCB 34. In a suited realization, the washer 46 has thickness of 0.1 mm, whereas the PCB 34 has a thickness of 1 mm. At least for the remote unit 20, in a preferred embodiment, an insulating core layer of the PCB 34 is made of FR-4.

Inserting the washer 46 between the sound duct 44 and the PCB 34, as shown in FIG. 3 and described above, results in effective acoustic low pass filtering of sound that propagates within the sound path formed by the opening 32, the sound passage 48, the bore 50 and the through-hole 40 towards the microphone port 42.

Optionally, in order to further improve said low pass filtering and improve ingress protection, at least one protection mesh (not shown) is inserted in said sound path. The at least one protection mesh is inserted between the housing wall 30 and the sound duct 44 and/or between the sound duct 44 and the washer 46. Furthermore, within the scope of the invention, the at least one protection mesh can also be inserted between the washer 46 and the PCB 34 and/or between the PCB 34 and the microphone 8, 24.

It will be appreciated by persons skilled in the art that numerous variations and/or modifications may be made to the invention as shown in the specific examples without departing from the spirit and scope of the invention as broadly described in the claims. The present examples are, therefore, to be considered in all aspects as illustrative and not restrictive. In particular, different from the examples shown in FIGS. 1 and 2, the hearing aid 4 may be realized as an ITE instrument or as an implanted instrument. Moreover, instead of the electro-acoustical receiver 10, the hearing aid 4 may comprise an electro-mechanical transducer or an output transducer directly stimulating the auditory nerve of the user.

### LIST OF REFERENCE NUMERALS

2 hearing system
4 hearing aid
6 housing
8 microphone
10 receiver
12 signal processor
14 wireless transceiver
16 sound channel
18 tip
20 remote unit
22 housing
24 microphone
26 controller
28 wireless transceiver
29 (wireless) link
30 housing wall
32 opening
34 PCB
36 (first) surface
38 (second) surface
40 through-hole
42 microphone port
44 sound duct
46 washer
48 sound passage
50 bore
I1 (first) input audio signal
I2 (second) input audio signal
O output audio signal

1. An electronic sound recording device in particular a hearing instrument comprising:
a housing having a housing wall and an opening formed therein through which opening sound can enter the housing;
a printed circuit board being arranged in said housing and having a through-hole that acts as a sound channel through said printed circuit board;
a microphone having a microphone port and being mounted on said printed circuit board such that said microphone port faces said printed circuit board and opens to said through-hole;
a sound duct having a sound passage formed therein and being arranged between the printed circuit board and the housing wall such that said sound passage connects said opening of the housing wall to said through-hole of the printed circuit board,
characterized in that
a washer having a bore is arranged between the printed circuit board and the sound duct such that the sound passage of the sound duct is connected to the through-hole of the printed circuit board via said bore of the washer, wherein said bore of the washer has a diameter smaller than both a diameter of said through-hole of the printed circuit board and a diameter of said sound passage of the sound duct.

2. The electronic sound recording device of claim 1, wherein the microphone is a MEMS microphone.

3. The electronic sound recording device of claim 1, wherein the washer abuts the printed circuit board.

4. The electronic sound recording device of claim 1,
wherein the washer is made of metal.

5. The electronic sound recording device of claim 1,
wherein the washer is soldered to the printed circuit board.

6. The electronic sound recording device of claim 1,
wherein the diameter of the bore of the washer is between 0.2 mm to 0.6 mm, preferably between 0.3 mm and 0.5 mm, in particular ca. 0.4 mm.

7. The electronic sound recording device of claim 1,
wherein the diameter of the through-hole of the printed circuit board is between 0.5 mm and 1.2 mm, preferably between 0.7 mm and 0.9 mm, in particular ca. 0.8 mm.

8. The electronic sound recording device of claim 1,
wherein at least one protection mesh spanning the bore of the washer or the through-hole of the printed circuit board is arranged between the washer and the sound duct and/or between the washer and the printed circuit board and/or between the printed circuit board and the microphone.
